(19) United States
(12) Patent Application Publication
(10) Pub. No.: US 2019/0202054 A1
(43) Pub. Date: Jul. 4, 2019

(54) AUTONOMOUSLY ACTING ROBOT, SERVER, AND BEHAVIOR CONTROL PROGRAM

(71) Applicant: GROOVE X, Inc., Tokyo (JP)

(72) Inventor: Kaname HAYASHI, Tokyo (JP)

(21) Appl. No.: 16/290,817

(22) Filed: Mar. 1, 2019

Related U.S. Application Data
(63) Continuation of application No. PCT/JP2017/030277, filed on Aug. 24, 2017.

(30) Foreign Application Priority Data
Sep. 2, 2016 (JP) 2016-171432

(51) Int. Cl. B25J 9/16; B25J 19/02; B25J 11/00

(52) U.S. Cl. CPC B25J 9/1664; B25J 11/001; B25J 19/026

(57) ABSTRACT

A robot includes an operation control unit that determines an execution track, which is a movement path of the robot, and a drive mechanism that causes the robot to move along the execution track. The robot generates a planned track corresponding to an event before the event occurs. When the event actually occurs while the robot is moving along the execution track, the robot moves along the planned track rather than the execution track. A multiple of planned tracks are generated sequentially with respect to one event, and when a multiple of planned tracks have already been generated when the event occurs, one planned track is selected from among the multiple of planned tracks.

### RELATED APPLICATIONS

The present application is a continuation of International Application No. PCT/JP2017/030277, filed Aug. 24, 2017, which claims priority from Japanese Application No. 2016-171432, filed Sep. 2, 2016, the disclosures of which applications are hereby incorporated by reference herein in their entirety.

### TECHNICAL FIELD

The present invention relates to a robot that autonomously selects an action in accordance with an internal state or an external environment.

### BACKGROUND ART

A human acquires various items of information from an external environment via sensory organs, and selects an action. There are times when an action is consciously selected, and times when an action is subconsciously selected. A repeated action becomes a subconscious action in time, and an action that is not repeated remains in a consciousness region.

A human believes that he or she has a will to freely select an action by him or herself, that is, a free will. That a human feels emotions of affection or enmity toward another person is because he or she believes that the other person also has a free will. A person who has free will, or at least an existence that can be supposed to have a free will, is also an existence that eases a person's loneliness.

A reason a human keeps a pet is that the pet provides solace, rather than whether or not the pet is useful to the human. Exactly because a pet is an existence that to a greater or lesser degree creates an impression of having a free will, the pet can become a good companion to a human.

Meanwhile, for various reasons such as not being able to secure sufficient time to look after a pet, not having a living environment in which a pet can be kept, having an allergy, or hating the thought of being parted by death, there are many people who give up on keeping a pet. If there were a robot that performed the role of a pet, it may be that people who cannot keep a pet would also be provided with the kind of solace that a pet provides (refer to Patent Documents 1 and 2).

### CITATION LIST

### Patent Literature

Patent Document 1: JP-A-2001-246580

Patent Document 2: JP-A-2006-39760

### SUMMARY OF INVENTION

### Technical Problem

Not only free will, but also “instinct” characterizes behavioral characteristics of a living being. Instinct is a reaction caused by a stimulus from an environment without accompanying a conscious judgment, with avoidance of danger being a typical example thereof. When a living being senses danger, the living being subconsciously and reflexively attempts to avoid the danger. It is thought that if a robot could be caused to adopt the same kind of danger avoiding behavior as a living being when recognizing danger, the robot's “presence as a living being” could be increased.

However, it is not easy for a robot to execute an appropriate avoidance action immediately after recognizing danger. When a calculation process for deciding how to escape and where to escape to takes too long after recognizing danger, movement becomes unnatural. Not being limited to a dangerous occurrence, reacting swiftly to some occurrence is important for realizing behavioral characteristics close to those of a living being with a robot.

The invention, having been completed based on a recognition of the heretofore described problem, has a main object of providing technology for efficiently controlling reflexive behavior of a robot in response to various occurrences occurring in an exterior.

### Solution to Problem

An autonomously acting robot in an aspect of the invention includes an operation control unit that determines an execution track, which is a movement path of the robot, a drive mechanism that causes the robot to move along the execution track, and a track generating unit that generates a planned track corresponding to an event before the event occurs.

When the event occurs when the robot is moving along the execution track, the operation control unit causes the robot to move along the planned track rather than the movement path.

A server in an aspect of the invention is connected via a communication line to an autonomously acting robot.

The server includes a track generating unit that generates a planned track corresponding to a position of the autonomously acting robot and an event, and a track notification unit that notifies the autonomously acting robot of the planned track before the event occurs.

An autonomously acting robot in another aspect of the invention includes an operation control unit that selects a motion of the robot, a drive mechanism that executes a motion selected by the operation control unit, and a safe point detecting unit that detects a point satisfying a predetermined safety condition as a safe point.

The operation control unit causes the robot to move to the safe point when a predetermined event occurs.

### Advantageous Effects of Invention

According to the invention, empathy toward a robot is easily increased.

### BRIEF DESCRIPTION OF DRAWINGS

FIG. 1A is a front external view of a robot.

FIG. 1B is a side external view of the robot.

FIG. 2 is a sectional view schematically representing a structure of the robot.

FIG. 3 is a configuration diagram of a robot system.

FIG. 4 is a schematic view of an emotion map.

FIG. 5 is a hardware configuration diagram of the robot.

FIG. 6 is a functional block diagram of the robot system.

FIG. 7 is a data structure diagram of a motion selection table.

FIG. 8 is a data structure diagram of a planned track selection table.

FIG. 9 is a schematic view showing a planned track generation method.

FIG. 10 is a schematic view illustrating an event envisaged during movement, and a planned track corresponding to the event.

FIG. 11 is a flowchart showing a flow of a planned track generating process.

FIG. 12 is a flowchart showing a process when an event occurs.

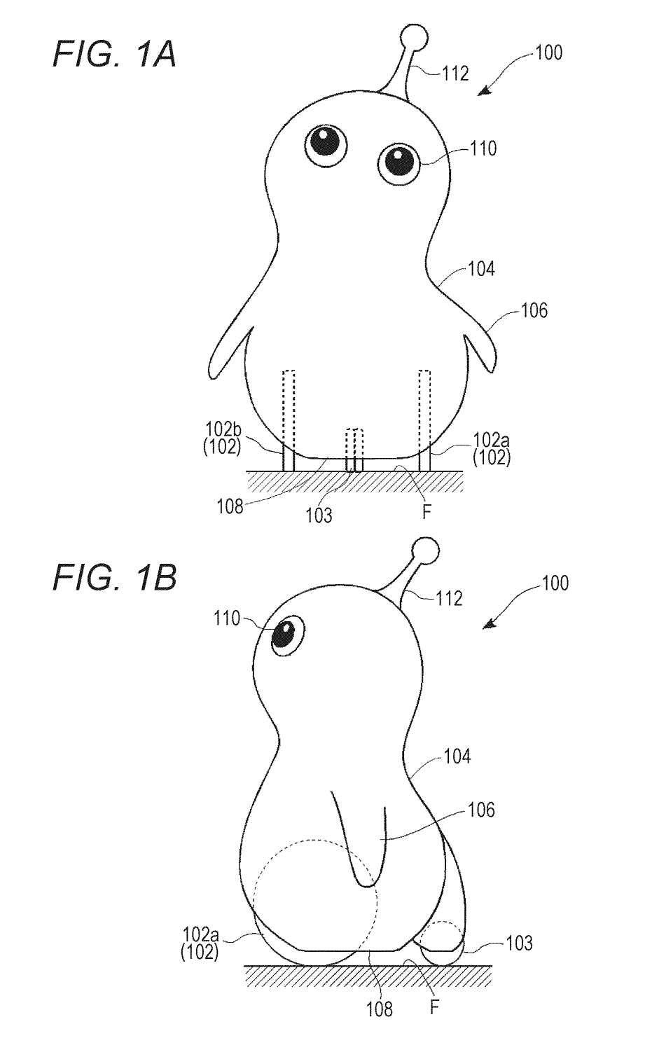

FIG. 1A is a front external view of a robot 100. FIG. 1B is a side external view of the robot 100.

The robot 100 in this embodiment is an autonomously acting robot that determines an action or gesture based on an external environment and an internal state. The external environment is recognized using various kinds of sensor, such as a camera or a thermosensor. The internal state is quantified as various parameters that express emotions of the robot 100. These will be described hereafter.

With indoor action as a precondition, the robot 100 has, for example, an interior of an owner's home as an action range. Hereafter, a human involved with the robot 100 will be called a “user”, and a user forming a member of a home to which the robot 100 belongs will be called an “owner”.

A body 104 of the robot 100 has a rounded form all over, and includes an outer skin formed of a soft material having elasticity, such as urethane, rubber, a resin, or a fiber. The robot 100 may be clothed. By the body 104, which is rounded, soft, and pleasant to touch, being adopted, the robot 100 provides a user with a sense of security and a pleasant tactile sensation.

A total weight of the robot 100 is 15 kilograms or less, preferably 10 kilograms or less, and more preferably still 5 kilograms or less. A majority of babies start to walk by themselves by 13 months after birth. An average weight of a baby 13 months after birth is a little over 9 kilograms for boys, and a little under 9 kilograms for girls. Because of this, when the total weight of the robot 100 is 10 kilograms or less, a user can hold the robot 100 with an effort practically equivalent to that of holding a baby that cannot walk by itself. An average weight of a baby less than 2 months after birth is less than 5 kilograms for both boys and girls. Consequently, when the total weight of the robot 100 is 5 kilograms or less, a user can hold the robot 100 with an effort practically equivalent to that of holding a very young baby.

Advantages of a user holding the robot 100 easily, and wanting to hold the robot 100, are realized by the attributes of appropriate weight and roundness, softness, and pleasantness of touch. For the same reasons, a height of the robot 100 is desirably 1.2 meters or less, or preferably 0.7 meters or less. Being able to be held is an important concept of the robot 100 in this embodiment.

The robot 100 includes three wheels for three-wheeled traveling. As shown in the drawings, the robot 100 includes a pair of front wheels 102 (a left wheel 102a and a right wheel 102b) and one rear wheel 103. The front wheels 102 are drive wheels, and the rear wheel 103 is a driven wheel. Although the front wheels 102 have no steering mechanism, rotational speed and a direction of rotation can be individually controlled. The rear wheel 103 is formed of a so-called omni wheel, and rotates freely in order to cause the robot 100 to move forward and back, and left and right. By controlling so that the rotational speed of the right wheel 102b is greater than that of the left wheel 102a, the robot 100 can turn left or rotate counterclockwise. By controlling so that the rotational speed of the left wheel 102a is greater than that of the right wheel 102b, the robot 100 can turn right or rotate clockwise.

The front wheels 102 and the rear wheel 103 can be completely stored in the body 104 using a drive mechanism (a pivoting mechanism and a linking mechanism). A greater portion of each wheel is hidden by the body 104 when traveling too, but when each wheel is completely stored in the body 104, the robot 100 is in a state of being unable to move. That is, the body 104 descends, and sits on a floor surface F, in accompaniment to an operation of the wheels being housed. In the sitting state, a flat seating face 108 (a ground bottom face) formed in a bottom portion of the body 104 comes into contact with the floor surface F.

The robot 100 has two arms 106. The arms 106 do not have a function of gripping an object. The arms 106 can perform simple actions such as raising, waving, and oscillating. The two arms 106 can also be controlled individually.

A camera is incorporated in an eye 110. The eye 110 is also capable of an image display using a liquid crystal element or an organic EL element. In addition to the camera incorporated in the eye 110, various sensors, such as a microphone array that can identify a sound source direction and an ultrasound sensor, are mounted in the robot 100. Also, the robot 100 incorporates a speaker, and is also capable of simple vocalization.

A horn 112 is attached to a head portion of the robot 100. As the robot 100 is lightweight, as heretofore described, a user can also lift up the robot 100 by grasping the horn 112. An omnidirectional camera is attached to the horn 112, and can film a whole region above the robot 100 at one time.

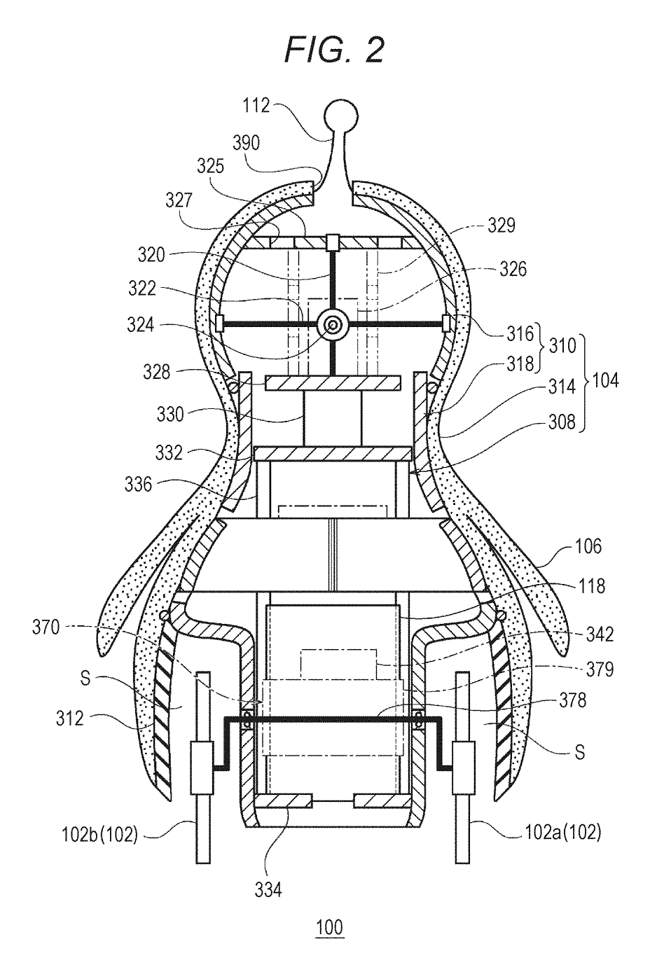

FIG. 2 is a sectional view schematically representing a structure of the robot 100.

As shown in FIG. 2, the body 104 of the robot 100 includes a base frame 308, a main body frame 310, a pair of wheel covers 312 made of resin, and an outer skin 314. The base frame 308 is formed of metal, and supports an internal mechanism together with configuring a shaft of the body 104. The base frame 308 is configured by an upper plate 332 and a lower plate 334 being linked vertically by a multiple of side plates 336. A sufficient interval is provided between the multiple of side plates 336 so that ventilation is possible. A battery 118, a control device 342, and various kinds of actuator are housed inside the base frame 308.

The main body frame 310 is formed of a resin material, and includes a head portion frame 316 and a trunk portion frame 318. The head portion frame 316 is of a hollow hemispherical form, and forms a head portion framework of the robot 100. The trunk portion frame 318 is of a stepped cylindrical form, and forms a trunk portion framework of the robot 100. The trunk portion frame 318 is integrally fixed to the base frame 308. The head portion frame 316 is attached to an upper end portion of the trunk portion frame 318 so as to be relatively displaceable.

Three shafts, those being a yaw shaft 320, a pitch shaft 322, and a roll shaft 324, and an actuator 326 for driving each shaft so as to rotate, are provided in the head portion frame 316. The actuator 326 includes a multiple of servo motors for driving each shaft individually. The yaw shaft 320 is driven for a head shaking action, the pitch shaft 322 is driven for a nodding action, and the roll shaft 324 is driven for a head tilting action.

A plate 325 that supports the yaw shaft 320 is fixed to an upper portion of the head portion frame 316. A multiple of ventilation holes 327 for securing ventilation between upper and lower portions are formed in the plate 325.

A base plate 328 made of metal is provided so as to support the head portion frame 316 and an internal mechanism thereof from below. The base plate 328 is linked to the plate 325 via a crosslink mechanism 329 (a pantagraph mechanism), and is linked to the upper plate 332 (the base frame 308) via a joint 330.

The trunk portion frame 318 houses the base frame 308 and a wheel drive mechanism 370. The wheel drive mechanism 370 includes a pivot shaft 378 and an actuator 379. A lower half portion of the trunk portion frame 318 is of a small width in order to form a housing space S of the front wheel 102 between the wheel covers 312.

The outer skin 314 is formed of urethane rubber, and covers the main body frame 310 and the wheel covers 312 from an outer side. The arms 106 are molded integrally with the outer skin 314. An aperture portion 390 for introducing external air is provided in an upper end portion of the outer skin 314.

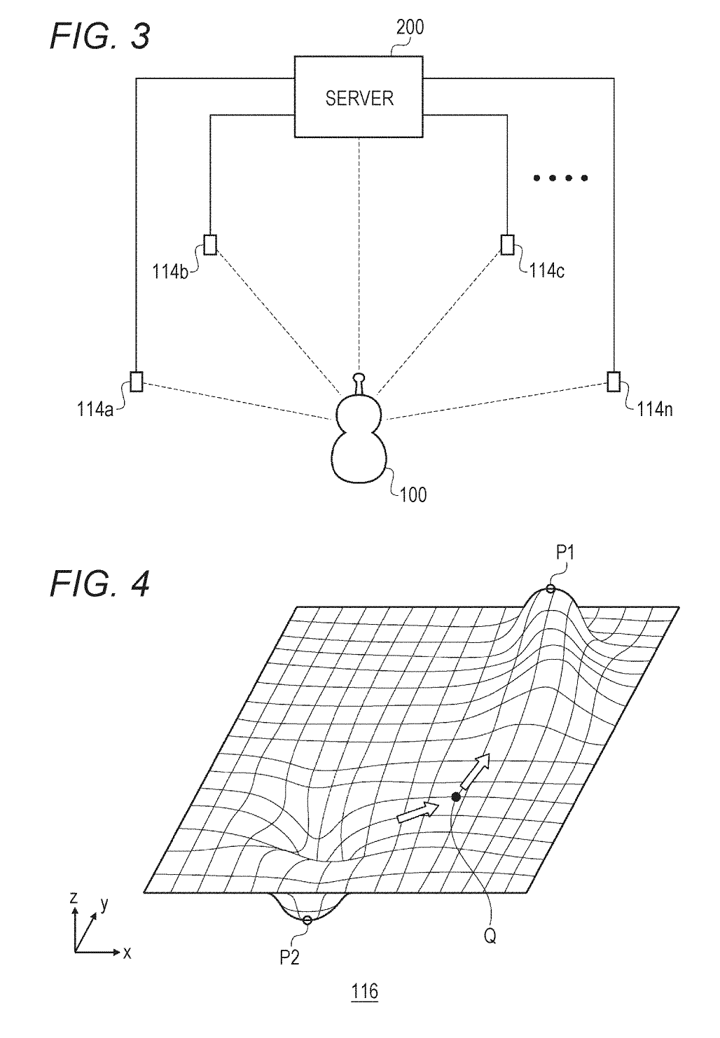

FIG. 3 is a configuration diagram of a robot system 300.

The robot system 300 includes the robot 100, a server 200, and a multiple of external sensors 114. The multiple of external sensors 114 (external sensors 114a, 114b, and so on to 114n) are installed in advance in a house. The external sensor 114 may be fixed to a wall surface of the house, or may be placed on a floor. Positional coordinates of the external sensor 114 are registered in the server 200. The positional coordinates are defined as x, y coordinates in the house envisaged to be an action range of the robot 100.

The server 200 is installed in the house. The server 200 and the robot 100 in this embodiment correspond one-to-one. The server 200 determines a basic action of the robot 100 based on information obtained from the sensors incorporated in the robot 100 and the multiple of external sensors 114.

The external sensor 114 is for reinforcing sensory organs of the robot 100, and the server 200 is for reinforcing brainpower of the robot 100.

The external sensor 114 regularly transmits a wireless signal (hereafter called a “robot search signal”) including ID (hereafter called “beacon ID”) of the external sensor 114. On receiving the robot search signal, the robot 100 returns a wireless signal (hereafter called a “robot response signal”) including beacon ID. The server 200 measures a time from the external sensor 114 transmitting the robot search signal until receiving the robot response signal, and measures a distance from the external sensor 114 to the robot 100. By measuring the distance between each of the multiple of external sensors 114 and the robot 100, the server 200 identifies the positional coordinates of the robot 100.

Of course, a method whereby the robot 100 regularly transmits its own positional coordinates to the server 200 may also be adopted.

FIG. 4 is a schematic view of an emotion map 116.

The emotion map 116 is a data table stored in the server 200. The robot 100 selects an action in accordance with the emotion map 116. The emotion map 116 shown in FIG. 4 shows a magnitude of an emotional attraction or aversion toward a place of the robot 100. An x axis and a y axis of the emotion map 116 indicate two-dimensional spatial coordinates. A z axis indicates a magnitude of an emotional attraction or aversion. When a z value is a positive value, an attraction toward the place is high, and when the z value is a negative value, the robot 100 is averse to the place.

On the emotion map 116 of FIG. 4, a coordinate P1 is a point in an indoor space managed by the server 200 as the action range of the robot 100 at which an emotion of attraction is high (hereafter called a favored point). The favored point may be a “safe place”, such as behind a sofa or under a table, or may be a place in which people tend to gather or a lively place, like a living room. Also, the safe place may be a place where the robot 100 was gently stroked or touched in the past.

A definition of what kind of place the robot 100 favors is arbitrary, but it is generally desirable that a place favored by small children, or by small animals such as dogs or cats, is set as a favored point.

A coordinate P2 is a point at which an emotion of aversion is high (hereafter called a “disliked point”). The disliked point may be a place where there is a loud noise, such as near a television, a place where there is likely to be a leak, like a bathroom or a washroom, an enclosed space or a dark place, a place where the robot 100 has been roughly treated by a user and that invokes an unpleasant memory, or the like.

A definition of what kind of place the robot 100 dislikes is also arbitrary, but it is generally desirable that a place feared by small children, or by small animals such as dogs or cats, is set as a disliked point.

A coordinate Q indicates a current position of the robot 100. The server 200 identifies positional coordinates of the robot 100, using the robot search signal regularly transmitted by the multiple of external sensors 114 and the robot response signal responding to the robot search signal. For example, when the external sensor 114 with beacon ID=1 and the external sensor 114 with beacon ID=2 each detect the robot 100, the server 200 obtains the distances of the robot 100 from the two external sensors 114, and obtains the positional coordinates of the robot 100 from the distances.

Alternatively, the external sensor 114 with beacon ID=1 transmits the robot search signal in a multiple of directions, and the robot 100 returns the robot response signal when receiving the robot search signal. By so doing, the server 200 may ascertain in which direction, and at what distance, the robot 100 is from which external sensor 114. Also, in another embodiment, the server 200 may calculate a distance moved by the robot 100 from the rotational speed of the front wheel 102 or the rear wheel 103, thereby identifying the current position, or may identify the current position based on an image obtained from the camera.

When the emotion map 116 shown in FIG. 4 is provided, the robot 100 moves in a direction toward the favored point (coordinate P1), or in a direction away from the disliked point (coordinate P2).

The emotion map 116 changes dynamically. When the robot 100 arrives at the coordinate P1, the z value (emotion of attraction) at the coordinate P1 decreases with the passing of time. Because of this, the robot 100 can emulate animal-like behavior of arriving at the favored point (coordinate P1), “being emotionally satisfied”, and in time “getting bored” with the place. In the same way, the emotion of aversion at the coordinate P2 is alleviated with the passing of time. A new favored point or disliked point appears together with the elapse of time, because of which the robot 100 carries out a new action selection. The robot 100 has “interest” in a new favored point, and ceaselessly carries out a new action selection.

The emotion map 116 expresses emotional swings as an internal state of the robot 100. The robot 100 heads for a favored point, avoids a disliked point, stays for a while at the favored point, and in time performs the next action. With this kind of control, the action selection of the robot 100 can be a human-like or animal-like action selection.

Maps that affect an action of the robot 100 (hereafter collectively called “action maps”) are not limited to the type of emotion map 116 shown in FIG. 4. For example, various action maps such as curiosity, a desire to avoid fear, a desire to seek safety, and a desire to seek physical ease such as quietude, low light, coolness, or warmth, can be defined. Further, an objective point of the robot 100 may be determined by taking a weighted average of the z values of each of a multiple of action maps.

The robot 100 also has, in addition to an action map, parameters that indicate a magnitude of various emotions or senses. For example, when a value of a loneliness emotion parameter is increasing, a weighting coefficient of an action map that evaluates places in which the robot 100 feels at ease is set high, and the value of this emotion parameter is reduced by the robot 100 reaching a target point. In the same way, when a value of a parameter indicating a sense of boredom is increasing, it is sufficient that a weighting coefficient of an action map that evaluates places in which curiosity is satisfied is set high.

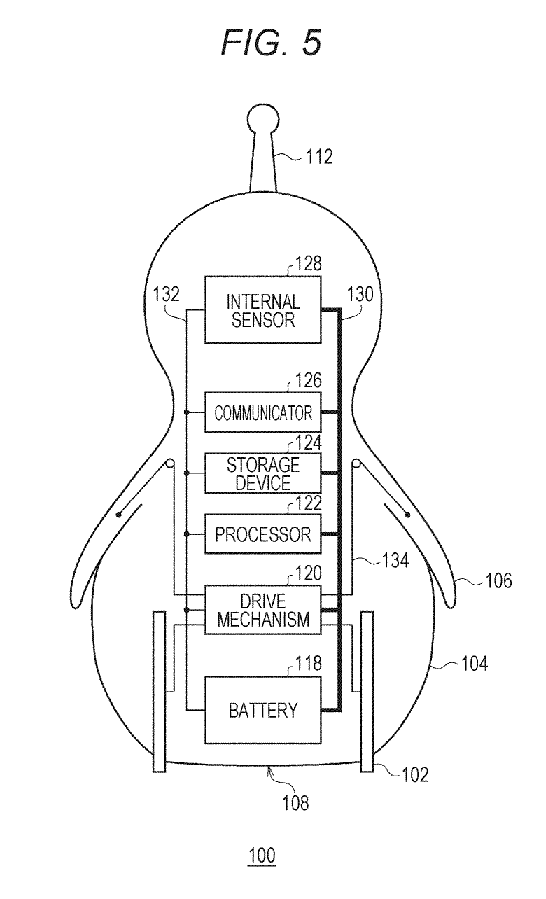

FIG. 5 is a hardware configuration diagram of the robot 100.

The robot 100 includes an internal sensor 128, a communicator 126, a storage device 124, a processor 122, a drive mechanism 120, and a battery 118. The drive mechanism 120 includes the heretofore described wheel drive mechanism 370. The processor 122 and the storage device 124 are included in the control circuit 342. The units are connected to each other by a power line 130 and a signal line 132. The battery 118 supplies power to each unit via the power line 130. Each unit transmits and receives a control signal via the signal line 132. The battery 118 is a lithium ion rechargeable battery, and is a power source of the robot 100.

The internal sensor 128 is a collection of various kinds of sensor incorporated in the robot 100. Specifically, there are cameras (a high resolution camera and an omnidirectional camera), a microphone array, an infrared sensor, a thermosensor, a touch sensor, an acceleration sensor, a smell sensor, and the like. The smell sensor is a commonly known sensor that applies a principle such that electrical resistance changes in accordance with adsorption of molecules that form a source of a smell. The smell sensor categorizes various smells into multiple kinds of category (hereafter called “smell categories”).

The communicator 126 is a communication module that carries out wireless communication with the server 200 and various kinds of external device, such as the external sensor 114 and a mobile device possessed by a user, as a target. The storage device 124 is configured of a non-volatile memory and a volatile memory, and stores a computer program and various kinds of setting information. The processor 122 is means of executing a computer program. The drive mechanism 120 is an actuator that controls an internal mechanism. In addition to this, an indicator, a speaker, and the like are also mounted.

The processor 122 selects an action of the robot 100 while communicating with the server 200 or the external sensor 114 via the communicator 126. Various kinds of external information obtained by the internal sensor 128 also affect the action selection. The drive mechanism 120 mainly controls the wheels (front wheels 102) and the head portion (the head portion frame 316). The drive mechanism 120 changes a direction of movement and a movement speed of the robot 100 by changing the rotational speed and the direction of rotation of each of the two front wheels 102. Also, the drive mechanism 120 can also raise and lower the wheels (the front wheels 102 and the rear wheel 103). When the wheels rise, the wheels are completely stored in the body 104, and the robot 100 comes into contact with the floor surface F via the seating face 108, taking on the sitting state.

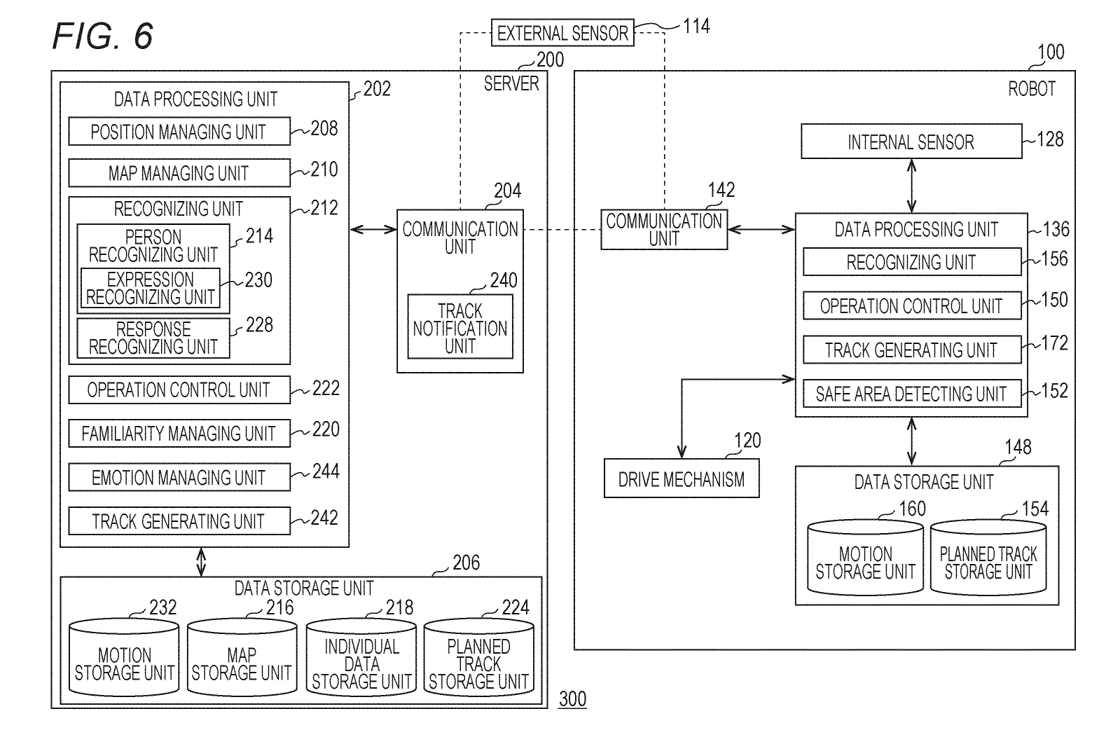

FIG. 6 is a functional block diagram of a robot system 300.

As heretofore described, the robot system 300 includes the robot 100, the server 200, and the multiple of external sensors 114. Each component of the robot 100 and the server 200 is realized by hardware including a computer formed of a CPU (central processing unit), various kinds of coprocessor, and the like, a storage device that is a memory or storage, and a wired or wireless communication line that links the computer and the storage device, and software that is stored in the storage device and supplies a processing command to the computer. A computer program may be configured of a device driver, an operating system, various kinds of application program positioned in an upper layer thereof, and a library that provides a common function to the programs. Each block described hereafter indicates a functional unit block rather than a hardware unit configuration.

One portion of the functions of the robot 100 may be realized by the server 200, and one portion or all of the functions of the server 200 may be realized by the robot 100.

Server 200

The server 200 includes a communication unit 204, a data processing unit 202, and a data storage unit 206.

The communication unit 204 manages a process of communicating with the external sensor 114 and the robot 100. The data storage unit 206 stores various kinds of data. The data processing unit 202 executes various kinds of process based on data acquired by the communication unit 204 and data stored in the data storage unit 206. The data processing unit 202 also functions as an interface of the communication unit 204 and the data storage unit 206.

The communication unit 204 includes a track notification unit 240. The track notification unit 240 notifies the robot 100 of a planned track and a planned track selection table generated by a track generating unit 242, to be described hereafter. The planned track and the planned track selection table will also be described hereafter.

The data storage unit 206 includes a motion storage unit 232, a map storage unit 216, an individual data storage unit 218, and a planned track storage unit 224.

The robot 100 has a multiple of operation patterns (motions). Various motions, such as waving a hand, approaching an owner while meandering, and staring at an owner with the head to one side, are defined.

The motion storage unit 232 stores control details of a motion (a motion file). Each motion is identified by motion ID. The motion file is also downloaded into a motion storage unit 160 of the robot 100. Which motion is to be executed may be determined in the server 200, or may be determined in the robot 100.

Many motions of the robot 100 are configured as compound motions that include a multiple of unit motions. For example, when the robot 100 approaches an owner, the approach may be expressed as a combination of a unit motion of changing direction to face the owner, a unit motion of approaching while raising an arm, a unit motion of approaching while shaking the body, and a unit motion of sitting while raising both arms. By combining these kinds of four motions, a motion of “approaching an owner, raising one arm on the way, and finally sitting after shaking the body” is realized. An angle of rotation, angular velocity, and the like of an actuator provided in the robot 100 is defined correlated to a time axis in a motion file. Various motions are performed by each actuator being controlled together with the passing of time in accordance with the motion file (actuator control information).

A shift time when changing from a preceding unit motion to a subsequent unit motion is called an “interval”. It is sufficient that an interval is defined in accordance with time needed for a unit motion change or details of a motion. A length of an interval can be regulated.

Hereafter, settings relating to controlling behavior of the robot 100, such as which motion is chosen and when, and regulating output of each actuator when a motion is realized, will collectively be called “behavioral characteristics”. Behavioral characteristics of the robot 100 are defined by a motion selection algorithm, a motion selection probability, a motion file, a planned track, a planned track selection table, and the like.

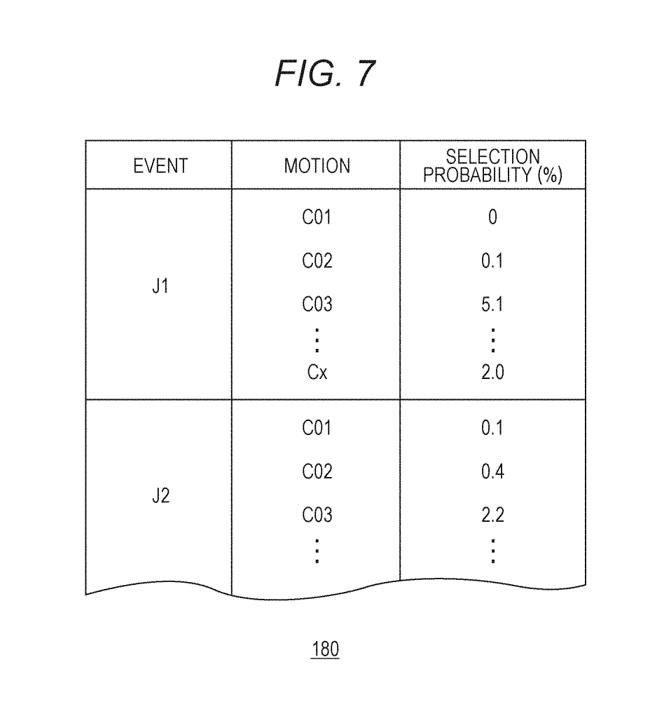

In addition to a motion file, the motion storage unit 232 stores a motion selection table that defines a motion that should be executed when various kinds of event occur. The motion selection table will be described hereafter in relation to FIG. 7.

In addition to a multiple of action maps, the map storage unit 216 also stores a map indicating a disposition situation of an obstacle such as a chair or a table. The planned track storage unit 224 stores a planned track. The planned track storage unit 224 stores a planned track and a planned track selection table (to be described hereafter). The individual data storage unit 218 stores information on a user, and in particular, on an owner. Specifically, the individual data storage unit 218 stores various kinds of parameter, such as familiarity with respect to a user, and physical characteristics and behavioral characteristics of a user. The individual data storage unit 218 may also store other attribute information such as age and gender.

The robot system 300 (the robot 100 and the server 200) categorizes a user based on the physical characteristics and the behavioral characteristics of the user. The robot 100 constantly films a periphery with the incorporated camera. Further, the robot 100 extracts the physical characteristics and the behavioral characteristics of a person appearing in an image. The physical characteristics may be visual characteristics associated with a body, such as a height, clothes worn by choice, a presence or absence of spectacles, a skin color, a hair color, and an ear size, or may also include other characteristics such as an average body temperature, a smell, and a voice quality. The behavioral characteristics, specifically, are characteristics accompanying behavior, such as a place the user favors, a briskness of movement, and a presence or absence of smoking. For example, the robot 100 extracts behavioral characteristics such that an owner categorized as a father is often out of the home, and is often motionless on a sofa when at home, but a mother is often in a kitchen, and an activity range is broad.

The robot system 300 clusters users appearing with a high frequency as “owners” based on physical characteristics and behavioral characteristics obtained from a large amount of image information and other sensing information.

Although the method of identifying a user from user ID is simple and reliable, the user having a device that can provide user ID is a precondition. Meanwhile, the method of identifying a user from physical characteristics or behavioral characteristics is such that an image recognition process is weighty, but there is an advantage in that even a user who does not have a mobile device can be identified. One of the two methods may be employed alone, or user identification may be carried out using the two methods together in a complementary way.

In this embodiment, users are clustered based on physical characteristics and behavioral characteristics, and a user is identified using deep learning (a multilayer neural network). Details will be described hereafter.

The robot 100 has a familiarity internal parameter for each user. When the robot 100 recognizes an action indicating a liking toward the robot 100, such as picking the robot 100 up or speaking to the robot 100, familiarity with respect to that user increases. Familiarity decreases with respect to a user not involved with the robot 100, a user who behaves roughly, or a user met infrequently.

The data processing unit 202 includes a position managing unit 208, a map managing unit 210, a recognizing unit 212, an operation control unit 222, a familiarity managing unit 220, an emotion managing unit 244, and the track generating unit 242.

The position managing unit 208 identifies the positional coordinates of the robot 100 using the method described using FIG. 3. The position managing unit 208 may also track positional coordinates of a user in real time.

The emotion managing unit 244 manages various emotion parameters indicating emotions (loneliness, enjoyment, fear, and the like) of the robot 100. These emotion parameters are constantly fluctuating. An importance of the multiple of action maps changes in accordance with the emotion parameters, the movement target point of the robot 100 changes depending on the action maps, and the emotion parameters change in accordance with movement of the robot 100 and the passing of time. For example, when the emotion parameter indicating loneliness is high, the emotion managing unit 244 sets the weighting coefficient of the action map that evaluates places in which the robot 100 feels at ease to be high. When the robot 100 reaches a point in the action map at which loneliness can be eliminated, the emotion managing unit 244 reduces the emotion parameter indicating loneliness. Also, each kind of emotion parameter also changes in accordance with a responsive action, to be described hereafter. For example, the emotion parameter indicating loneliness decreases when the robot 100 is “hugged” by an owner, and the emotion parameter indicating loneliness gradually increases when the robot 100 does not visually recognize an owner for a long time.

The map managing unit 210 changes the parameter of each coordinate on the multiple of action maps using the method described in connection with FIG. 4. The map managing unit 210 may select one of the multiple of action maps, or may take a weighted average of the z values of the multiple of action maps. For example, it is taken that the z values at a coordinate R1 and a coordinate R2 on an action map A are 4 and 3, and the z values at the coordinate R1 and the coordinate R2 on an action map B are −1 and 3. When taking a simple average, the total z value at the coordinate R1 is 4−1=3, and the total z value at the coordinate R2 is 3+3=6, because of which the robot 100 heads in the direction of the coordinate R2 rather than the coordinate R1.

When the action map A is weighted 5 times with respect to the action map B, the total z value at the coordinate R1 is 4×5−1=19, and the total z value at the coordinate R2 is 3×5+3=18, because of which the robot 100 heads in the direction of the coordinate R1.

The recognizing unit 212 recognizes an external environment. Various kinds of recognition, such as recognition of weather or season based on temperature and humidity, and recognition of shelter (a safe area) based on an amount of light and temperature, are included in the recognition of the external environment. The recognizing unit 156 of the robot 100 acquires various kinds of environmental information using the internal sensor 128, and transfers the environmental information to the recognizing unit 212 of the server 200 after carrying out a primary process thereon. Specifically, the recognizing unit 156 of the robot 100 extracts images corresponding to moving objects, particularly people or animals, from an image, and sends the extracted images to the server 200. The recognizing unit 212 of the server 200 extracts characteristics of a person appearing in the extracted images.

The recognizing unit 212 further includes a person recognizing unit 214 and a response recognizing unit 228. The person recognizing unit 214 recognizes a person from an image filmed by the camera incorporated in the robot 100, and extracts the physical characteristics and the behavioral characteristics of the person. Further, based on the physical characteristic information and the behavioral characteristic information registered in the individual data storage unit 218, the person recognizing unit 214 determines what person, such as a father, a mother, or an eldest son, the user filmed, that is, the user the robot 100 is looking at, corresponds to. The person recognizing unit 214 includes an expression recognizing unit 230. The expression recognizing unit 230 infers an emotion of a user using image recognition of an expression of the user.

The person recognizing unit 214 also extracts characteristics of a moving object other than a person, for example, a cat or a dog that is a pet.

The response recognizing unit 228 recognizes various responsive actions performed with respect to the robot 100, and classifies the actions as pleasant or unpleasant actions. Also, the response recognizing unit 228 recognizes a responsive action of an owner with respect to an action of the robot 100, thereby classifying the responsive action as a positive or negative response.

Pleasant and unpleasant actions are distinguished depending on whether a responsive action of a user is pleasing or unpleasant for an animal. For example, being hugged is a pleasant action for the robot 100, and being kicked is an unpleasant action for the robot 100. Positive and negative responses are distinguished depending on whether a responsive action of a user indicates a pleasant emotion or an unpleasant emotion of the user. For example, being hugged is a positive response indicating a pleasant emotion of the user, and being kicked is a negative response indicating an unpleasant emotion of the user.

The operation control unit 222 of the server 200 determines a motion of the robot 100 in cooperation with an operation control unit 150 of the robot 100. Also, the operation determining unit 222 of the server 200 compiles a movement target point of the robot 100, and an execution track (a movement route) for the movement target point, based on an action map selection by the map managing unit 210. In the embodiment, the operation control unit 222 compiles a multiple of execution tracks, and having done so, selects one of the execution tracks. An “execution track” is route information specifying a movement target point and a path until reaching the movement target point, and the robot 100 moves along the selected execution track. In addition to a movement target point and the like, an execution track also defines a transit point and a movement speed.

The operation control unit 222 selects a motion of the robot 100 from a multiple of motions of the motion storage unit 232. A selection probability is correlated to each motion for each situation. For example, a selection method such that a motion A is executed with a 20% probability when a pleasant action is performed by an owner, and a motion B is executed with a 5% probability when a temperature reaches 30 degrees or higher, is defined.

A movement target point and an execution track are determined by an action map, and a motion is selected in accordance with various kinds of event, to be described hereafter.

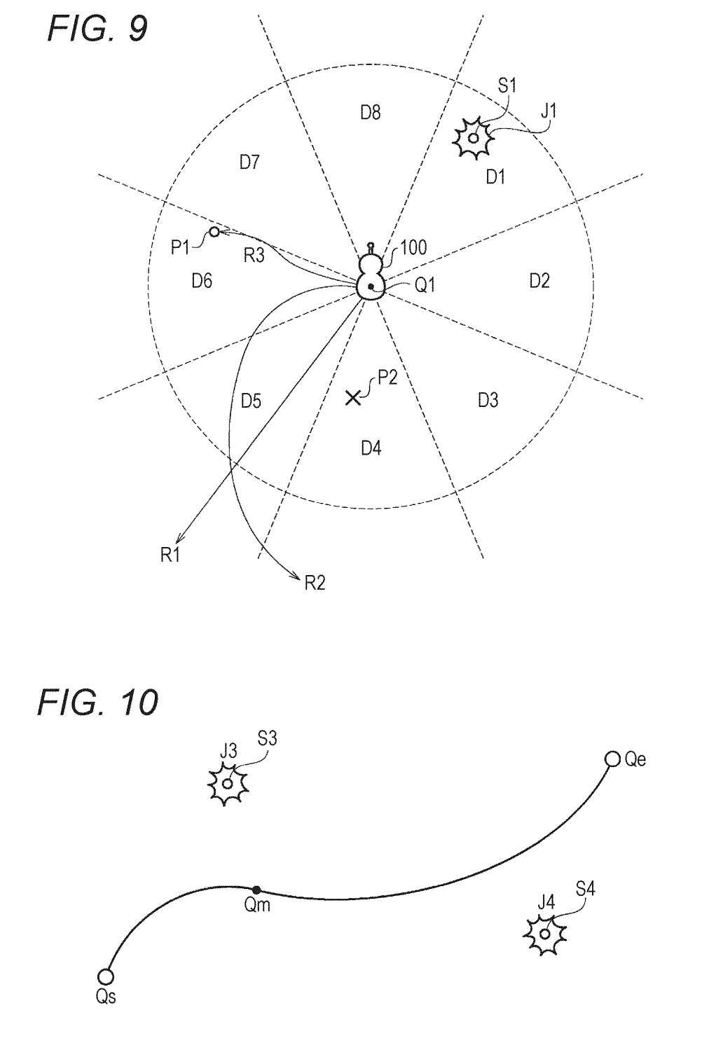

The track generating unit 242 generates a planned track that defines a movement route of the robot 100 when an event occurs, and a planned track selection table that indicates a planned track selection method. A planned track generation method will be described in detail hereafter in relation to FIG. 9, FIG. 10, and the like. A “planned track” is route information specifying a movement target point and a path until reaching the movement target point. In addition to a movement target point and the like, a planned track in the embodiment also defines a transit point and a movement speed. An “execution track” is a track that is invariably employed when selected, but a “planned track” is a track that is not employed unless an event occurs. When a planned track is generated, the planned track selection table of the planned track storage unit 224 is updated, and the robot 100 is notified by the track notification unit 240. A planned track storage unit 154 of the robot 100 also has a planned track selection table. An update of the planned track selection table of the server 200 is reflected in the planned track selection table of the robot 100 by the track notification unit 240.

The familiarity managing unit 220 manages familiarity for each user. As heretofore described, familiarity is registered as one portion of individual data in the individual data storage unit 218. When a pleasant action is detected, the familiarity managing unit 220 increases familiarity with respect to that owner. When an unpleasant action is detected, the familiarity managing unit 220 reduces familiarity. Also, familiarity of an owner not visually recognized for a long period gradually decreases.

Robot 100

The robot 100 includes a communication unit 142, a data processing unit 136, a data storage unit 148, the internal sensor 128, and the drive mechanism 120.

The communication unit 142 corresponds to the communicator 126 (refer to FIG. 5), and manages a process of communicating with the external sensor 114 and the server 200. The data storage unit 148 stores various kinds of data. The data storage unit 148 corresponds to the storage device 124 (refer to FIG. 5). The data processing unit 136 executes various kinds of process based on data acquired by the communication unit 142 and data stored in the data storage unit 148. The data processing unit 136 corresponds to the processor 122 and a computer program executed by the processor 122. The data processing unit 136 also functions as an interface of the communication unit 142, the internal sensor 128, the drive mechanism 120, and the data storage unit 148.

The data storage unit 148 includes the motion storage unit 160, which defines various kinds of motion of the robot 100, and the planned track storage unit 154, in which planned track data are stored.

Various kinds of motion file are downloaded into the motion storage unit 160 of the robot 100 from the motion storage unit 232 of the server 200. A motion is identified by motion ID. An operation timing, an operating time, an operating direction, and the like, of the various kinds of actuator (the drive mechanism 120) are defined chronologically in a motion file in order to perform various motions such as sitting by housing the front wheel 102, raising the arm 106, causing the robot 100 to carry out a rotating action by causing the two front wheels 102 to rotate in reverse or by causing only one front wheel 102 to rotate, shaking by causing the front wheel 102 to rotate in a state in which the front wheel 102 is housed, or stopping once and looking back when moving away from a user.

A planned track of the robot 100 is generated by both a track generating unit 172 of the robot 100 and the track generating unit 242 of the server 200. A planned track and a planned track selection table generated by the track generating unit 172 of the robot 100 are stored in the planned track storage unit 154. A planned track and a planned track selection table generated by the track generating unit 242 of the server 200 are stored in the planned track storage unit 224. The planned track selection table and data defining a planned track stored in the planned track storage unit 224 of the server 200 are downloaded as necessary into the planned track storage unit 154 of the robot 100 by the track notification unit 240.

The data processing unit 136 includes the recognizing unit 156, the operation control unit 150, a safe area detecting unit 152, and the track generating unit 172.

The operation control unit 150 of the robot 100 determines a motion of the robot 100 in cooperation with the operation control unit 222 of the server 200. One portion of motions may be determined by the server 200, and other motions may be determined by the robot 100. Also, a configuration may be such that the robot 100 determines a motion, but the server 200 determines a motion when a processing load of the robot 100 is high. A motion that forms a base may be determined by the server 200, and an additional motion may be determined by the robot 100. It is sufficient that a way in which a motion determining process is shared between the server 200 and the robot 100 is designed in accordance with specifications of the robot system 300.

The operation control unit 150 of the robot 100 determines a direction of movement of the robot 100 together with the operation control unit 222 of the server 200. Movement based on an action map may be determined by the server 200, and an immediate movement such as avoiding an obstacle may be determined by the operation control unit 150 of the robot 100. The operation control unit 150 may determine an execution track. The drive mechanism 120 causes the robot 100 to head toward a movement target point by driving the front wheel 102 in accordance with an instruction from the operation control unit 150.

The operation control unit 150 of the robot 100 instructs the drive mechanism 120 to execute a selected motion. The drive mechanism 120 controls each actuator in accordance with the motion file.

The operation control unit 150 can also execute a motion of holding up both arms 106 as a gesture asking for “a hug” when a user with a high degree of familiarity is nearby, and can also perform a motion of no longer wanting to be hugged by repeatedly causing the left and right front wheels 102 to alternately rotate in reverse and stop in a housed state when bored of the “hug”. The drive mechanism 120 causes the robot 100 to perform various motions by driving the front wheel 102, the arm 106, and the neck (head portion frame 316) in accordance with an instruction from the operation control unit 150.

The track generating unit 172 generates a planned track of the robot 100 together with the track generating unit 242 of the server 200, and updates the planned track selection table. A planned track and a planned track selection table generated by the track generating unit 172 of the robot 100 are stored in the planned track storage unit 154. Planned tracks stored in the planned track storage unit 154 include planned tracks generated by the track generating unit 172 of the robot 100 and planned tracks generated by the track generating unit 242 of the server 200. Also, the planned track selection table of the planned track storage unit 154 is updated by the track generating unit 172, and also updated by the track generating unit 242 of the server 200.

The safe area detecting unit 152 detects a safe area. A safe area, and a method of detecting a safe area, will be described hereafter.

The recognizing unit 156 of the robot 100 analyzes external information obtained from the internal sensor 128. The recognizing unit 156 is capable of visual recognition (a visual unit), smell recognition (an olfactory unit), sound recognition (an aural unit), and tactile recognition (a tactile unit).

The recognizing unit 156 regularly films an exterior angle using the internal camera (the internal sensor 128), and detects a moving object such as a person or a pet. An image of the moving object is transmitted to the server 200, and the person recognizing unit 214 of the server 200 extracts the physical characteristics of the moving object. Also, the recognizing unit 156 also detects a smell of a user and a voice of a user. Smell and sound (voice) are categorized into multiple kinds using an already known method.

When a strong force is applied to the robot 100, the recognizing unit 156 recognizes this using an incorporated acceleration sensor, and the response recognizing unit 228 of the server 200 recognizes that a “violent action” has been performed by a user in the vicinity. When a user picks the robot 100 up by grabbing the horn 112, this may also be recognized as a violent action. When a user in a state of confronting the robot 100 speaks in a specific volume region and a specific frequency band, the response recognizing unit 228 of the server 200 may recognize that a “speaking action” has been performed with respect to the robot 100. Also, when a temperature in the region of body temperature is detected, the response recognizing unit 228 of the server 200 recognizes that a “touching action” has been performed by a user, and when upward acceleration is detected in a state in which touching is recognized, the response recognizing unit 228 of the server 200 recognizes that a “hug” has been performed. Physical contact when a user raises the body 104 may also be sensed, and a hug may also be recognized by a load acting on the front wheels 102 decreasing.

The response recognizing unit 228 of the server 200 recognizes various kinds of response by a user toward the robot 100. “Pleasant” or “unpleasant”, “positive” or “negative” is correlated to one portion of typical responsive actions among various kinds of responsive action. In general, almost all responsive actions that are pleasant actions are positive responses, and almost all responsive actions that are unpleasant actions are negative responses. Pleasant and unpleasant actions relate to familiarity, and positive and negative responses affect action selection of the robot 100.

Of a series of recognition processes including detection, analysis, and determination, the recognizing unit 156 of the robot 100 carries out a selection and categorization of information necessary for recognition, and an interpreting process such as analysis or determination is executed by the recognizing unit 212 of the server 200. The recognition processes may be carried out by the recognizing unit 212 of the server 200 alone, or carried out by the recognizing unit 156 of the robot 100 alone, or both may execute the recognizing processes while allotting roles, as heretofore described.

The familiarity managing unit 220 of the server 200 changes the familiarity toward a user in accordance with a responsive action recognized by the recognizing unit 156. Essentially, the familiarity toward a user who carries out a pleasant action increases, while the familiarity toward a user who carries out an unpleasant action decreases.

The recognizing unit 212 of the server 200 may determine whether a response is pleasant or unpleasant, and the map managing unit 210 of the server 200 may change the z value of the point at which the pleasant or unpleasant action has been carried out on an action map that represents “attachment to a place”. For example, when a pleasant action is carried out in a living room, the map managing unit 210 may set a favored point at a high probability in the living room. In this case, a positive feedback advantage is realized in that the robot 100 favors the living room, and further favors the living room due to being the recipient of a pleasant action in the living room.

The person recognizing unit 214 of the server 200 detects a moving object from various kinds of data obtained from the external sensor 114 or the internal sensor 128, and extracts characteristics (physical characteristics and behavioral characteristics) thereof. Further, the person recognizing unit 214 cluster analyzes multiple moving objects based on these characteristics. Not only a human, but also a pet such as a dog or cat, may be a target of analysis as a moving object.

The robot 100 regularly carries out image filming, and the person recognizing unit 214 recognizes a moving object from the images, and extracts characteristics of the moving object. When a moving object is detected, physical characteristics and behavioral characteristics are also extracted from the smell sensor, the incorporated highly directional microphone, the temperature sensor, and the like. For example, when a moving object appears in an image, various characteristics are extracted, such as having a beard, being active early in the morning, wearing red clothing, smelling of perfume, having a loud voice, wearing spectacles, wearing a skirt, having white hair, being tall, being plump, being suntanned, or being on a sofa.

When a moving object (user) having a beard is often active early in the morning (gets up early) and rarely wears red clothing, a first profile that is a cluster (user) that gets up early, has a beard, and does not often wear red clothing is created. Meanwhile, when a moving object wearing spectacles often wears a skirt, but the moving object does not have a beard, a second profile that is a cluster (user) that wears spectacles and wears a skirt, but definitely does not have a beard, is created.

Although the above is a simple example, the first profile corresponding to a father and the second profile corresponding to a mother are formed using the heretofore described method, and the robot 100 recognizes that there at least two users (owners) in this house.

Note that the robot 100 does not need to recognize that the first profile is the “father”. In all cases, it is sufficient that the robot 100 can recognize a figure that is “a cluster that has a beard, often gets up early, and hardly ever wears red clothing”.

It is assumed that the robot 100 newly recognizes a moving object (user) in a state in which this kind of cluster analysis is completed.

At this time, the person recognizing unit 214 of the server 200 extracts characteristics from sensing information of an image or the like obtained from the robot 100, and determines which cluster a moving object near the robot 100 corresponds to using deep learning (a multilayer neural network). For example, when a moving object that has a beard is detected, the probability of the moving object being the father is high. When the moving object is active early in the morning, it is still more certain that the moving object corresponds to the father. Meanwhile, when a moving object that wears spectacles is detected, there is a possibility of the moving object being the mother. When the moving object has a beard, the moving object is neither the mother nor the father, because of which the person recognizing unit 214 determines that the moving object is a new person who has not been cluster analyzed.

Formation of a cluster by characteristic extraction (cluster analysis) and application to a cluster accompanying characteristic extraction (deep learning) may be executed concurrently.

Familiarity toward a moving object (user) changes in accordance with how the robot 100 is treated by the user.

The robot 100 sets a high familiarity for a frequently met person, a person who frequently touches the robot 100, and a person who frequently speaks to the robot 100. Meanwhile, familiarity decreases for a rarely seen person, a person who does not often touch the robot 100, a violent person, and a person who scolds in a loud voice. The robot 100 changes the familiarity of each user based on various items of exterior angle information detected by the sensors (visual, tactile, and aural).

The actual robot 100 autonomously carries out a complex action selection in accordance with an action map. The robot 100 acts while being affected by a multiple of action maps based on various parameters such as loneliness, boredom, and curiosity. When the effect of the action maps is removed, or when in an internal state in which the effect of the action maps is small, the robot 100 essentially attempts to approach a person with high familiarity, and attempts to move away from a person with low familiarity.

Actions of the robot 100 are classified below in accordance with familiarity.

(1) A Cluster with Extremely High Familiarity

The robot 100 strongly expresses a feeling of affection by approaching a user (hereafter called “an approaching action”), and by performing an affectionate gesture defined in advance as a gesture indicating goodwill toward a person.

(2) A Cluster with Comparatively High Familiarity

The robot 100 carries out only an approaching action.

(3) A Cluster with Comparatively Low Familiarity

The robot 100 does not carry out any special action.

(4) A Cluster with Particularly Low Familiarity

The robot 100 carries out a withdrawing action.

According to the heretofore described control method, the robot 100 approaches the user when finding a user with high familiarity, and conversely, moves away from the user when finding a user with low familiarity. According to this kind of control method, the robot 100 can express by behavior a so-called “shyness”. Also, when a visitor (a user A with low familiarity) appears, the robot 100 may move away from the visitor and head toward a family member (a user B with high familiarity). In this case, user B can perceive that the robot 100 is shy and feeling uneasy, and relying on user B. Owing to this kind of behavioral expression, pleasure at being chosen and relied upon, and an accompanying feeling of affection, are evoked in user B.

Meanwhile, when user A, who is a visitor, visits frequently, and speaks to and touches the robot 100, familiarity of the robot 100 toward user A gradually rises, and the robot 100 ceases to perform an action of shyness (a withdrawing action) with respect to user A. User A can also feel affection toward the robot 100 by perceiving that the robot 100 has become accustomed to user A.

The heretofore described action selection need not necessarily be executed constantly. For example, when an internal parameter indicating curiosity of the robot 100 is high, weight is given to an action map from which a place in which the curiosity is satisfied is obtained, because of which there is also a possibility that the robot 100 does not select an action affected by familiarity. Also, when the external sensor 114 installed in the hall detects the return home of a user, the robot 100 may execute an action of greeting the user with maximum priority.

FIG. 7 is a data structure diagram of a motion selection table 180.

The motion selection table 180 defines a motion to be executed when various kinds of event occur. When an event occurs, the robot 100 selects one or more motions from multiple kinds of motion. The motion selection table 180 is stored in both the motion storage unit 232 of the server 200 and the motion storage unit 160 of the robot 100. The motion selection table 180 of the server 200 and the motion selection table 180 of the robot 100 are synchronized with each other. An “event” is defined in advance as an occurrence that forms a trigger for the robot 100 to execute a motion. Setting details of an event are arbitrary, such as when visually recognizing an owner, when being hugged by an owner, when being kicked, when a loud sound is heard, or when not visually recognizing anyone for a predetermined time or longer.

When referring to FIG. 7, a selection probability is correlated to each of a motion (C01) to a motion (Cx) for an event J1. For example, when the event J1 occurs, the operation control unit 222 does not select the motion (C01), and selects the motion (C02) at a probability of 0.1%. When an event J2 occurs, the operation control unit 222 selects the motion (C01) at a probability of 0.1%, and selects the motion (C02) at a probability of 0.4%.

While there are simple events detected by the recognizing unit 156 of the robot 100, there are also complex events for which interpretation by the person recognizing unit 214 of the server 200 is needed. When the recognizing unit 156 of the robot 100 recognizes an event, the operation control unit 150 selects a motion by referring to the motion selection table 180, and instructs the drive mechanism 120 to execute the motion. When the recognizing unit 212 of the server 200 recognizes an event, the operation control unit 222 of the server 200 selects a motion by referring to the motion selection table 180 stored in the motion storage unit 232, and notifies the robot 100 of the motion ID. The operation control unit 150 of the robot 100 instructs the drive mechanism 120 to execute a motion corresponding to the motion ID notified of.

A selection probability in the motion selection table 180 need not be a fixed value. The operation control unit 222 causes the selection probability to change at random within a certain range. When a selection probability of the motion selection table 180 is updated in the server 200, the motion selection table 180 after updating is downloaded into the robot 100.

Events are classified into positive events, negative events, and neutral events. A positive event is a pleasant sensation, for example, when a pleasant action is performed. Specifically, a positive event is being stroked by an owner, favored music playing, moving to a cool place when the external temperature is high, or the like. A negative event is an event correlated to unpleasantness or danger. Specifically, a negative event is being subjected to a violent action, detecting an unpleasant sound such as an object falling or breaking, coming into contact with an extremely hot or cold object, or the like. A negative event can also be defined based on recognition of a voice such as a shout, a scream, a shrill voice, or a rebuke. A neutral event is an event that is neither a positive event nor a negative event.

Various motions, such as staring in the direction in which the event occurs, flapping the arm 106, bumping against an object that is a source of the event occurring, or directing the body in the direction in which the event occurs, can be defined in response to each event.

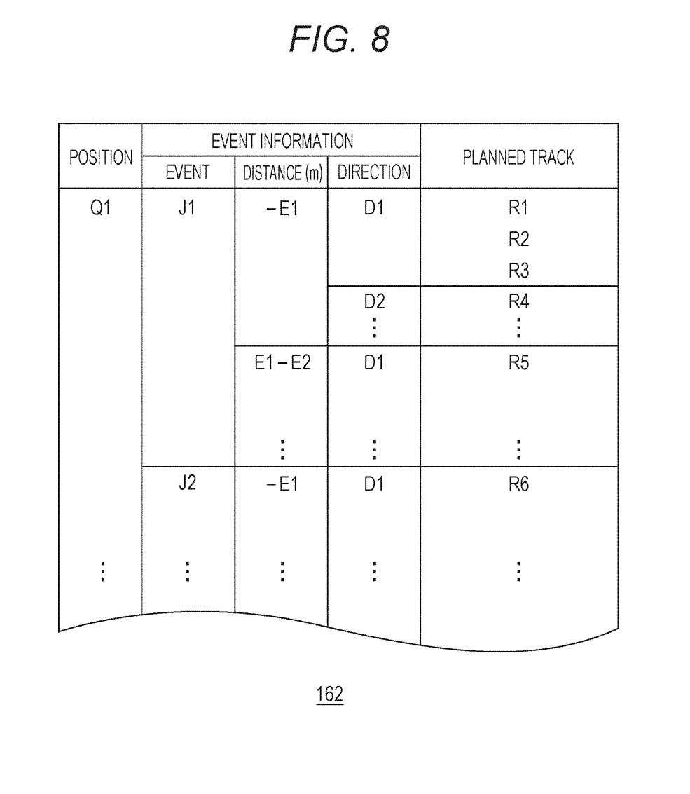

FIG. 8 is a data structure diagram of a planned track selection table 162.

The planned track selection table 162 defines a planned track to be selected when various kinds of event occur. When an event, particularly a negative event, occurs, the robot 100 moves along a planned track after executing a motion corresponding to the event. For example, when subjected to a violent action (a negative event), the robot 100 escapes from the person committing the violent action (the source of the event occurring). This escape route is also one kind of planned track. When an event occurs, the robot 100 selects one planned track from one or more planned tracks.

In particular, an instant movement is often needed in response to a negative event. When recognizing a negative event such as unpleasantness or danger, a living being attempts to move away from danger immediately. In the case of the robot 100, there is a possibility of a delay occurring in an action when calculating an escape route after detecting a negative event. The embodiment is such that rather than calculating a movement route corresponding to an event after the event occurs, one or more movement routes (planned tracks) are calculated in advance before an event occurs, whereby an instant movement when an event occurs is realized.

A planned track differs depending on what kind of event occurs and where, and where the robot 100 is at the time. In the planned track selection table 162 shown in FIG. 8, R1 to R3 are set as planned tracks for when the robot 100 is at a positional coordinate Q1, and the event J1 occurs a short distance of Elm or less from Q1 and in a D1 direction (for example, a front right direction) as seen from the robot 100. These planned tracks are calculated before the event J1 actually occurs. When the event J1 actually occurs, the operation control unit 150 selects one of the planned tracks R1 to R3, and causes the robot 100 to move along the selected planned track. Selection probabilities may be set for a multiple of planned tracks.

Hereafter, an event occurrence situation wherein the event J1 occurs a short distance of Elm or less from Q1 and in the D1 direction as seen from the robot 100, when the robot 100 is at the positional coordinate Q1, will be written as “Q1, (J1, E1, D1)”.

The track generating unit 172 of the robot 100 sequentially generates planned tracks for various events. In the same way, the track generating unit 242 of the server 200 also sequentially generates planned tracks. For example, a configuration may be such that before the event occurrence situation “Q1, (J1, E1, D1)” actually occurs, the track generating unit 172 of the robot 100 generates the planned track R1 corresponding to the event occurrence situation, and the track generating unit 242 of the server 200 generates a planned track R4 for a different event occurrence situation “Q1, (J1, E1, D2)”. In this case, the track generating unit 172 of the robot 100 transmits an instruction to generate a planned track (hereafter called a “track generation instruction”) for the event occurrence situation “Q1, (J1, E1, D1)” to the server 200. With reception of a track generation instruction as a condition, the server 200 generates a planned track corresponding to the event occurrence situation indicated in the track generation instruction. The track generating unit 242 of the server 200 updates the planned tracks and the planned track selection table of the planned track storage unit 224, and the track notification unit 240 notifies the robot 100 of the generated planned track R4.

The robot 100 may generate the planned track R1 by itself, and transmit track generation instructions for the planned tracks R2 and R3 to the server 200. A configuration may be such that only the track generating unit 172 of the robot 100 calculates a planned track, or such that only the track generating unit 242 of the server 200 calculates a planned track. It is sufficient that planned track calculation is shared in accordance with the processing loads of the robot 100 and the server 200.

In the embodiment, a description is given assuming that a planned track based on an action map is generated by the track generating unit 242 of the server 200, and a simple planned track that does not utilize an action map is generated by the safe area detecting unit 152 of the robot 100.

Various movement methods, such as where to move to, what kind of route to move along, whether to move hurriedly, and whether to move slowly, are defined in planned track data. Also, a motion that should be executed simultaneously when moving along a planned track may also be set. For example, various motions, such as escaping with both the arms 106 raised or dashing after retreating a little, can be set.

FIG. 9 is a schematic view showing a planned track generation method.

FIG. 9 shows the event occurrence situation “Q1, (J1, E1, D1)”. The planned tracks R1 to R3 are generated in response to this situation (refer to FIG. 8). The planned track R1 is a simple route, which does not consider an action map, of escaping straight ahead in a direction opposite to that of an event occurrence point S1. When there is an obstacle in the planned track R1, the robot 100 moves so as to move a predetermined distance or more away from the source of the event occurring while performing an operation of avoiding the obstacle. The planned track R2 is a movement route that moves away from the event occurrence point S1 while maintaining a predetermined distance or more from a disliked point P2. The planned track R3 is a movement route that heads toward a nearest favored point P1.

The track generating unit 172 of the robot 100 generates the planned track R1. As the planned track R1 is simple, the planned track R1 may be set in advance as a movement route that can invariably be selected when a negative event occurs. The planned track R2 is generated by the track generating unit 242 of the server 200. The track generating unit 242 refers to an action map such as the emotion map 116, and generates a movement route that avoids the disliked point P2. For example, after setting a condition such that the robot 100 does not enter within a predetermined range from the disliked point P2, the track generating unit 242 sets the planned track R2 in a direction that increases the distance from the event occurrence point. The planned track R3 is also generated by the track generating unit 242 of the server 200. The track generating unit 242 refers to an action map, and generates a movement route that moves away from the event occurrence point S1, and heads toward the favored point P1 nearest to the current point Q1, as the planned track R3. The planned track R3 is generated after the generation of the planned track R2 is completed.

The track generating unit 172 of the robot 100 generates the planned track R1, and transmits a track generation instruction to the track generating unit 242 of the server 200. The track generating unit 242 firstly generates the planned track R2, then generates the planned track R3. The robot 100 is sequentially notified of the planned tracks R2 and R3 by the server 200. As a result, the planned tracks are generated in the order R1, R2, and R3.

When the event J1 occurs when only the planned track R1 has been generated, the operation control unit 150 of the robot 100 causes the robot 100 to move along the planned track R1. When the event J1 occurs when both the planned track R1 and the planned track R2 have been generated, the operation control unit 150 of the robot 100 selects one of the planned track R1 or the planned track R2 at random. When the event J1 occurs after the generation of the planned tracks R1 to R3, the operation control unit 150 of the robot 100 selects one of the planned tracks R1 to R3 at random.

According to this kind of control method, a multiple of planned tracks are generated before the event occurrence situation “Q1, (J1, E1, D1)” arises, meaning that when the event J1 actually occurs, one planned track is chosen from among the planned tracks that can be selected at the point of occurrence. It is sufficient that the robot 100 and the server 200 generate planned tracks as necessary as a background process of low execution priority.

The planned tracks R2 and R3, which take the favored point P1 and the disliked point P2 into consideration, are generated by the server 200 while referring to an action map.

In a modified example, an action map may also be downloaded into the robot 100. In this case, the robot 100 can also generate the planned tracks R2 and R3 based on the action map. Also, in addition to moving away from the event occurrence point S1, various planned tracks that do not rely on an action map, such as circling the current point Q1 or moving a little closer to the event occurrence point S1 and watching, may be generated in the robot 100 too.

Also, a configuration may be such that a planned track that is simple and has a short calculation processing time is calculated first, and a complex planned track that takes an action map into consideration is calculated later. In this case, when a multiple of planned tracks are already calculated when an event occurs, a latest, or in other words a most complex, planned track may be employed.

By generating a multiple of planned tracks corresponding to a certain event occurrence situation in advance, responsive behavior of the robot 100 with respect to the event can be varied. Also, by generating a planned track based on an action map, a planned track based on the behavioral characteristics of the robot 100 can be generated.

The server 200 sequentially generates multiple kinds of event occurrence situation, and in particular, various planned tracks corresponding to multiple kinds of event. The robot 100 is notified of a generated planned track at a stage at which the event is yet to occur. According to this kind of control method, the robot 100 can prepare for an event that might occur in the future.

The server 200 may generate a planned track on condition that a track generation instruction is received, and even when a track generation instruction is not received, the server 200 may generate planned tracks corresponding to various event occurrence situations, and cause the planned track storage unit 154 of the robot 100 to record the planned tracks as necessary.

There is also a case in which a planned track is generated as a route for hiding in a safe point. A safe point is a place where the robot 100 is easily protected, such as near an owner, behind a wall, behind a sofa, a small room such as a bathroom or a toilet, or a place with a ceiling, such as under a desk or a table. The map storage unit 216 of the server 200 stores a map in which positional coordinates of a safe point are registered in advance. The track generating unit 242 of the server 200 can also generate a planned track that has a nearest safe point as a movement target point.

The robot 100 can search for a safe point by itself. The safe area detecting unit 152 of the robot 100 detects a point that satisfies a predetermined safety condition as a “safe point”. Specifically, a safe point is a place where there is a “ceiling”, like under a table, a place where there is a “friendly owner” whose familiarity is of a predetermined value or greater, a dark place like behind a sofa, a place in which three directions or more are enclosed by walls, like a bathroom, or the like. The robot 100 detects a place where a safety condition is satisfied by recognizing an owner, a ceiling, or a wall using the internal sensor 128, particularly the camera. When finding a place that satisfies a safety condition at a time of normal behavior, the safe area detecting unit 152 notifies the server 200. The map managing unit 210 of the robot 100 registers the positional coordinates of the robot 100 at the point of notification as a safe point.

As heretofore described, when an event occurs, the robot 100 executes a motion corresponding to the event. Subsequently, the robot 100 immediately moves along one planned track. For example, when a loud explosive sound is heard, behavioral characteristics of executing a motion of shuddering with fright, then immediately escaping from the sound source, can be expressed. A motion may be executed while moving along a planned track. For example, a behavioral expression of slowly escaping while staring at the source of the event occurring can be realized.

FIG. 10 is a schematic view illustrating an event envisaged during movement, and a planned track corresponding to the event.

In FIG. 10, the robot 100 sets normal movement (an execution track) from a start point Qs to an end point Qe. This may be movement because Qe is a favored point, or may be movement for moving away from Qs because a vicinity of Qs has become a disliked point. There is a possibility of various events occurring during movement. There is a television at a coordinate S3, and there is a possibility of an event of a “loud sound” caused by the television occurring. There is a child at a coordinate S4, and the child may cause a “loud sound” to be emitted, or may commit a violent action on the robot 100.

An order of priority is set in advance for an event. It is sufficient that the order of priority is initially set arbitrarily when designing, based on frequency of occurrence and importance. Herein, it is assumed that there are the event J3 that can occur at the coordinate S3 and the event J4 that can occur at the coordinate S4, and that the order of priority of the event J3 is higher than that of the event J4. In this case, the robot system 300 calculates a planned track with the event J3 as a target before calculating a planned track with the event J4 as a target.

The robot 100 or the server 200 firstly calculates a planned track corresponding to the event J3. For example, the robot 100 or the server 200 calculates a planned track corresponding to an event occurrence situation “Qm, (J3, E1, D3)”. Herein, Qm is a transit point between Qs and Qe. After the calculation is completed, the robot 100 or the server 200 may calculate a planned track corresponding to another event occurrence situation “Qm, (J3, E1, D4)” or “Qm, (J4, E1, D2)”. A multiple of planned tracks are generated corresponding to various situations in this way, thereby preparing for a situation in which the event J3 or J4 actually occurs. The greater the number of planned tracks that are already generated, the more varied the behavioral expression corresponding to an event can be.

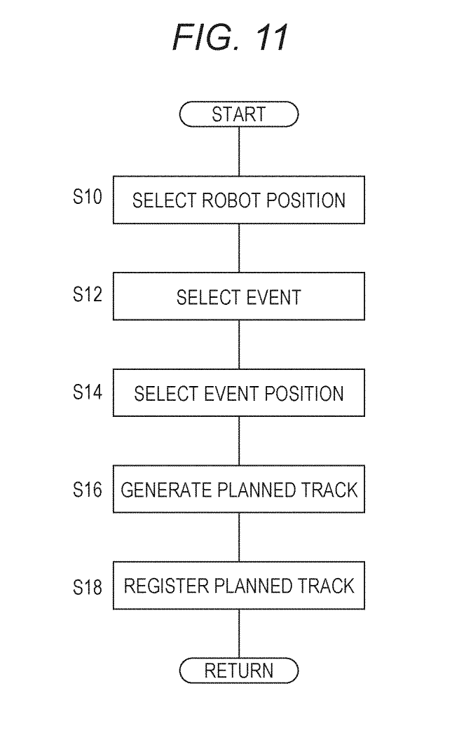

FIG. 11 is a flowchart showing a flow of a planned track generating process.

The planned track generating process is executed by both the robot 100 and the server 200. Herein, a description will be given with the track generating unit 242 of the server 200 as a subject, but the same applies to the track generating unit 172 of the robot 100. As the execution priority of the planned track generating process of the server 200 is low, the process is executed in a time band in which the processing load of the server 200 is light. The planned track generating process may be executed regularly, or may be executed every time the robot 100 moves a predetermined distance.

The track generating unit 242 selects the positional coordinates of the robot 100 when an event occurs (S10). When the robot 100 is moving or scheduled to move, the track generating unit 242 identifies a multiple of candidate points at which the robot 100 can be positioned in future, and selects with one of the candidate points as a calculation target. Next, the track generating unit 242 selects an event that is to be a calculation target from among multiple kinds of event (S12). It is sufficient that events are sequentially selected based on order of priority, as heretofore described. The track generating unit 242 selects one point from among points at which an event can occur (S14). As described in relation to FIG. 8 and FIG. 9, one point at which an event can occur is selected from among a multiple of distance ranges (for example, two kinds, those being “less than E1” and “E1 or greater, less than E2”) and a multiple of directions (for example, eight directions, those being D1 to D8).

The track generating unit 242 generates a planned track corresponding to an event occurrence situation identified as heretofore described (S16). The planned track is such that, after choosing whether to move away from or approach the event occurrence point, a multiple of parameters such as a movement target point and a movement speed are selected at random, and a route is set while considering an existence of an action map or an indoor obstacle. A combination of a multiple of movement methods, such as circling, meandering, and advancing directly, may be selected at random as a way of approaching the movement target point. Data on the generated planned track are registered in the planned track storage unit 224, and the track generating unit 242 updates the planned track selection table 162 (S18). Also, the track generating unit 242 may delete a planned track calculated in the past but no longer needed from the planned track selection table 162. Information in the planned track storage unit 224 is reflected as necessary in the planned track storage unit 154 of the robot 100 by the track notification unit 240.

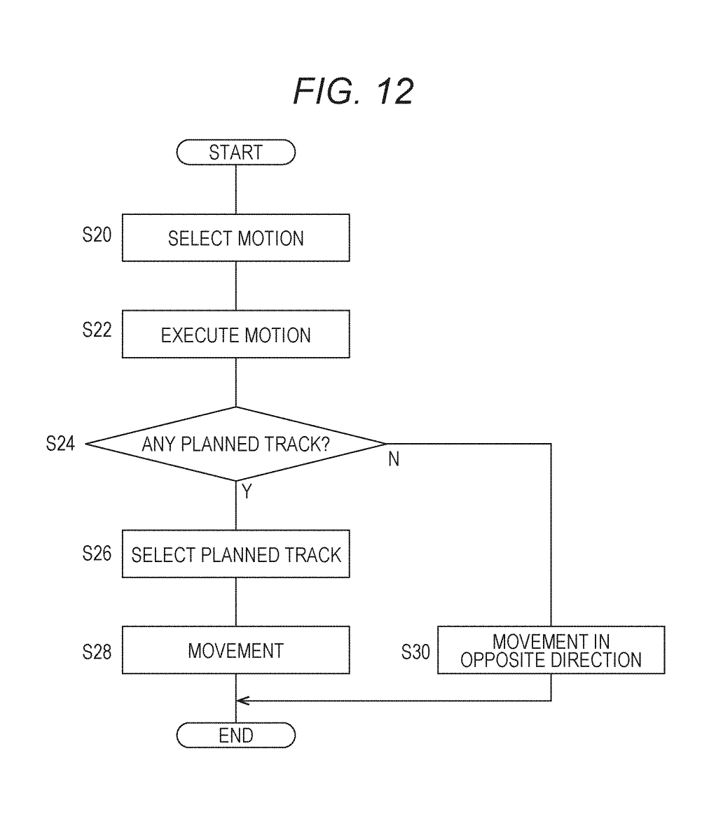

FIG. 12 is a flowchart showing a process when an event occurs.

The process shown in FIG. 12 is executed in the robot 100. When an event occurs, the operation control unit 150 of the robot 100 selects a motion by referring to the motion selection table 180 (S20), and causes the drive mechanism 120 to execute the selected motion (S22). When one or more planned tracks corresponding to the materialized event occurrence situation have already been generated (Y in S24), the operation control unit 150 selects a planned track (S26), and causes movement along the planned track to be executed by instructing the drive mechanism 120 (S28). Meanwhile, when no planned track corresponding to the event occurrence situation has been generated (N in S24), the operation control unit 150 causes the robot 100 to move a predetermined distance in a direction directly away from the source of the event occurring (S30).

In this way, a basic movement corresponding to an event occurrence can be executed even when an event occurrence situation for which no planned track has been generated occurs. The robot 100 may be caused to move along a planned track without executing a motion corresponding to an event.

Heretofore, the robot 100 and the robot system 300 including the robot 100 have been described based on the embodiment.

The robot 100 performs an action selection that cannot be patterned using one or more action maps, and which is difficult to predict and animal-like. In the same way as a living being, behavior of the robot 100 changes in accordance with not only an action map, but also various kinds of event. In the embodiment, the robot 100 moves along a planned track after executing a motion corresponding to an event. According to this kind of control method, behavior of escaping in surprise when recognizing a dangerous or unpleasant event can be expressed.

By a planned track being calculated by both the server 200 and the robot 100, a calculation load of the robot 100 can be lightened. The server 200 may calculate all planned tracks. Planned tracks are generated and accumulated while envisaging various event occurrence situations, and the robot 100 is caused to move along a planned track when an event actually occurs, because of which an immediate action in response to an event can be realized. Also, by generating a multiple of planned tracks with respect to a certain event occurrence situation, a response of the robot 100 to the same event is varied.

There being no need to generate a large number of planned tracks in advance before an event occurs, it is sufficient to sequentially generate a multiple of planned tracks when the load is light in accordance with the calculation load situation. Further, one planned track is selected from among planned tracks already generated at a point at which an event occurs. According to this kind of control method, behavioral variety and immediate response are balanced.

By generating a planned track having a safe point as a movement target point, behavioral characteristics of taking refuge in a safe place when sensing danger can be realized. The robot 100 can also find a safe point that satisfies a safety condition at a time of normal behavior. The map managing unit 210 may register this kind of safe point as “a place that provides a sense of ease” in an action map. In this case, behavioral characteristics of favoring a safe point can be realized.

The invention not being limited to the heretofore described embodiment or a modified example, components can be changed or embodied without departing from the scope of the invention. Various inventions may be formed by a multiple of the components disclosed in the heretofore described embodiment or the modified example being combined as appropriate. Also, some components may be eliminated from the total of components shown in the heretofore described embodiment or the modified example.

Although a description has been given assuming that the robot system 300 is configured of one robot 100, one server 200, and the multiple of external sensors 114, one portion of the functions of the robot 100 may be realized by the server 200, and one portion or all of the functions of the server 200 may be allocated to the robot 100. One server 200 may control a multiple of the robot 100, or a multiple of the server 200 may control one or more of the robot 100 in cooperation.

A third device other than the robot 100 and the server 200 may manage one portion of functions. A collection of the functions of the robot 100 and the functions of the server 200 described in FIG. 7 can also be comprehensively grasped as one “robot”. It is sufficient that a method of distributing the multiple of functions needed in order to realize the invention with respect to one or multiple items of hardware is determined with consideration to the processing capability of each item of hardware, specifications required of the robot system 300, and the like.

As heretofore described, “the robot in a narrow sense” is the robot 100 excluding the server 200, but “the robot in a wide sense” is the robot system 300. It is thought that there is a possibility of many functions of the server 200 being integrated in the robot 100 in future.

The robot 100 may calculate a simple planned track, and a complex planned track may be calculated by the server 200. For example, a planned track that heads toward a safe point and a planned track based on an action map may be calculated by the server 200. Planned track calculation by the robot 100 and planned track calculation by the server 200 may be executed concurrently. A configuration may be such that the robot 100 identifies an event occurrence situation, and notifies the server 200 of an event occurrence situation for which the robot 100 wishes a planned track to be calculated, and the server 200 calculates a corresponding planned track.

The robot 100 may actively entrust planned track calculation to the server 200 when the calculation load of the robot 100 is large, or when an amount of heat generated by the processor 122 is large. Also, the robot 100 need not always move in response to an event. For example, when a sound of an impact is heard from far away, “surprise” may be expressed behaviorally by being transfixed to the spot.

Not only simply escaping from a negative event, but also various planned tracks, such as slowly approaching a little before moving away at high speed, or circling the source of an event occurring, can be set. Also, a planned track may be generated in advance not only for a negative event but also for a positive event. For example, when an owner comes home also, various planned tracks, such as heading directly to the hall, waiting before the hall, or hiding in the kitchen, may be prepared.

An event order of priority can be set arbitrarily when the robot system 300 is designed. Of multiple kinds of event defined in advance, the track generating unit 242 of the server 200 may set the order of priority of an event relating to a person, particularly an event relating to an owner with high familiarity, to be high. The track generating unit 242 may set a high order of priority for an event that has often occurred in a predetermined period in the past. By setting an order of priority for an event, a calculation resource for planned track calculation can be distributed with emphasis placed on an important event.

The track generating unit 242 may delete a once-calculated planned track after a predetermined time elapses.

The server 200 may control a multiple of robots 100 simultaneously. The track generating unit 242 of the server 200 generates an individual planned track in accordance with an action map or familiarity of each robot 100. For example, when an event of “an object falling and breaking” occurs, a first robot 100A might escape behind the father, and a second robot 100B might escape behind a sofa.

In addition to an action map or familiarity, a planned track may be calculated based on various parameters such as robot size or movement speed. Various behavior reflecting an individuality of the robot 100, such as a personality unlikely to be affected by a negative event or a timid personality that immediately escapes to a safe spot, can be expressed.

The robot system 300 need not include a planned track calculating function, a safe point detecting function, or the like from the time of shipping from the factory. After the robot system 300 is shipped, functional strengthening of the robot system 300 may be realized by downloading a behavior control program that realizes the planned track calculating function and the like via a communication network.

In the embodiment, a description has been given assuming that the operation control unit 222 of the server 200 or the operation control unit 150 of the robot 100 generates an execution track. As a modified example, a configuration may be such that the track generating unit 242 of the server 200 or the track generating unit 172 of the robot 100 generates not only a planned track but also an execution track, and the operation control unit 222 or the like selects the generated execution track.

### ADDITIONAL EXAMPLE

The track generating unit 242 of the server 200 or the track generating unit 172 of the robot 100 generates planned track data, and registers the planned track data in the planned track selection table 162. When an event occurs, the operation control unit 150 sets a movement target point in accordance with the planned track data. The recognizing unit 156 films the periphery using the camera, thereby detecting an obstacle existing within a visually recognizable short distance. An “obstacle” is determined as an object having a predetermined height. When an obstacle is detected in a planned track, the track generating unit 172 calculates a new planned track for reaching the movement target point by avoiding the obstacle. When an obstacle is discovered when the robot 100 is moving along an execution track (normal movement route), the operation control unit 150, in the same way, generates a new execution track avoiding the obstacle.

Also, the safe area detecting unit 152 regularly detects a safe point based on an image filmed by the camera. The safe area detecting unit 152 registers a safe point within a predetermined range of the current point of the robot 100 in a list (hereafter called a “safe point list”), and updates the safe point list as necessary in accompaniment to movement of the robot 100. Not only a safe point newly detected by the safe area detecting unit 152, but also a safe point registered in advance in a map, is included in the safe point list. In an additional example, a maximum of five safe points are registered in order of proximity to the robot 100 in the safe point list. The safe point list is a list of nearest safe points to which the robot 100 should escape when an event occurs. In the additional example, the track generating unit 242 or the like generates as necessary planned tracks having one or more safe points registered in the safe point list as movement target points. These planned tracks are generated for each safe point for each event, and stocked.

When a predetermined event such as an object falling, a loud sound occurring, or being hit occurs, the operation control unit 150 chooses one safe point from the safe point list as a movement target point. When a multiple of safe points are registered in the safe point list, the operation control unit 150 may choose the nearest safe point to the current point, or may choose at random. Also, a level of priority may be set in advance for a safe point. For example, a level of priority higher than that of “behind a sofa” may be set in advance for a place where there is a “friendly owner”.

When a predetermined event, for example, a negative event, occurs while the robot 100 is stationary, the operation control unit 150 chooses a safe point from the safe point list, and sets a planned track having the safe point as a movement target point. When no safe point is registered in the safe point list, the operation control unit 150 sets a movement target point in a direction away from the direction in which the event has occurred. Even when an event occurs when the robot 100 sets a movement target point A and is executing a movement fixed in advance, the operation control unit 150 chooses a safe point from the safe point list, and sets the safe point as a new movement target point B. At this time, the execution track having the movement target point A as a target is cancelled, and the robot 100 moves toward the new movement target point B (the safe point). According to this kind of control method, a target can be changed to movement to a safe point when an event occurs, even when the robot 100 is stationary or moving. The operation control unit 150 may select a safe point after an event occurs, or may choose a safe point in advance before an event occurs. In either case, by selecting a safe point before an event occurs, and generating a planned track having the safe point as a movement target point, the robot 100 can be caused to express behavior of swiftly escaping to a safe point when an event occurs.

As heretofore described, when the operation control unit 150 determines a movement path (execution track), the track generating unit 172 generates a planned track in preparation for an event. When the event actually occurs while the robot 100 is moving along an execution track, the operation control unit 150 causes the robot 100 to move along the planned track rather than the execution track. At this time, the execution track is cancelled. Meanwhile, when one safe point from the safe point list is deleted from movement destination candidates in accompaniment to movement of the robot 100, a planned track generated corresponding to the safe point is also annulled.

1. A robot, comprising:
a non-transitory computer readable medium configured to store instructions thereon;
a processor connected to the non-transitory computer readable medium, wherein the processor is configured to execute the instructions for:
determining an execution track, wherein the execution track is a movement path of the robot;
generating a planned track corresponding to an event prior to detecting the event; and
instructing the non-transitory computer readable medium to store the planned track generated previously; and
a drive mechanism configured to cause the robot to move along the execution track, wherein, in response to detecting the event during movement along the execution track, the processor is configured to instruct the drive mechanism to cause the robot to move along the planned track instead of the execution track.

2. The robot according to claim 1, wherein the processor is configured to execute the instructions for:
sequentially generating multiple planned tracks corresponding to the event, and
selecting one planned track from the multiple planned tracks in response to the multiple planned tracks having been generated when the event is detected.

3. The robot according to claim 1, wherein the processor is configured to execute the instructions for:
generating multiple planned tracks, wherein each planned track of the multiple planned tracks corresponds to an event of multiple events, and
selecting a planned track of the multiple planned tracks, wherein the selected planned track corresponds to the detected event of the multiple events.

4. The robot according to claim 3, wherein the processor is configured to execute the instructions for sequentially generating the multiple planned tracks based on an order of priority of the multiple events.

5. The robot according to claim 1, wherein the processor is configured to execute the instructions for:
generating multiple planned tracks, wherein each planned track of the multiple planned tracks corresponds to a location of a plurality of locations at which an event is expected to be detected,
selecting a planned track of the multiple planned tracks corresponding to the location of the plurality of locations at which the event is detected.

6. The robot according to claim 1, wherein the processor is configured to execute the instructions for:
instructing the drive mechanism to execute a predetermined motion, in response to detection of the event, prior to moving along the planned track.

7. The robot according to claim 6, wherein the processor is configured to execute the instructions for:
selecting the predetermined motion from a plurality of motions based on the detected event.

8. The robot according to claim 1, wherein the processor is configured to execute the instructions for:
detecting a location satisfying a predetermined safety condition as a safe point, and
generating the planned track having the safe point as a destination.

9. The robot according to claim 1, further comprising a sensor configured to receive a sound signal, wherein the processor is configured to execute the instructions for detecting the event in response to a volume of the received sound signal being greater than a predetermined volume.

10. The robot according to claim 1, further comprising a sensor configured to detect a temperature of an object, wherein the processor is configured to execute the instructions for detecting the event in response to the robot contacting an object having a detected temperature equal to or higher than a predetermined temperature.

11. The robot according to claim 1, further comprising a sensor configured to detect a temperature of an object, wherein the processor is configured to execute the instructions for detecting the event in response to the robot contacting an object having a detected temperature equal to or lower than a predetermined temperature.

12. The robot according to claim 1, further comprising a sensor configured to detect a position of an object, wherein the processor is configured to execute the instructions for:
determining whether the detected object is recognized, and
generating the planned tracks for moving the robot to a location within a predetermined distance from the detected position in response to the object being recognized.

13. The robot according to claim 1, further comprising a sensor for detecting a location of the event, wherein the processor is configured to execute the instructions for generating the planned track based on a direction from the robot in which the event is detected.

14. A server comprising:
a non-transitory computer readable medium configured to store instructions thereon; and
a processor connected to the non-transitory computer readable medium, wherein the processor is configured to execute the instructions for:
determining an execution track, wherein the execution track is a movement path for a robot;
generating a planned track, wherein the planned track is generated based on a position of the robot and an event;
instructing the non-transitory computer readable medium configured to store the planned track, and
transmitting the planned track to the robot prior to the event occurring.

15. The server according to claim 14, wherein the processor is configured to execute the instructions for generating the planned track in response to a track generation signal received from the robot.

16. The server according to claim 14, wherein the processor is configured to execute the instructions for generating the planned track based on stored behavioral characteristics of the robot.

17. The server according to claim 14, wherein the processor is configured to execute the instructions for:
calculating multiple planned tracks, wherein each planned track of the multiple planned tracks corresponds to an event of multiple events,
transmitting each of the multiple planned tracks to the robot prior to any of the multiple events occurring.

18. The server according to claim 14, wherein the processor is configured to execute the instructions for:
generating multiple planned tracks, wherein each planned track of the multiple planned tracks corresponds to a location of multiple locations at which an occurrence of an event is expected,
transmitting the multiple planned tracks to the robot prior to any of the multiple events occurring.

19. The server according to claim 14, wherein the processor is configured to execute the instructions for:
setting a safe point satisfying a predetermined safety condition, and
generating the planned track using the safe point as a destination.

20. A robot, comprising:
a sensor configured to detect a parameter from an environment surrounding the robot;
a non-transitory computer readable medium configured to store instructions and a plurality of planned tracks thereon;
a processor connected to the non-transitory computer readable medium, wherein the processor is configured to execute the instructions for:
determining an execution track, wherein the execution track is a movement path of the robot;
selecting, in response to detection of an event, a planned track of the plurality of planned tracks based on information from the sensor; and
a drive mechanism configured to cause the robot to move along the execution track, wherein, in response to detecting the event during movement along the execution track, the processor is configured to instruct the drive mechanism to cause the robot to move along the selected planned track instead of the execution track.
